(19) United States
(12) Patent Application Publication
(10) Pub. No.: US 2006/0191761 A1
(43) Pub. Date: Aug. 31, 2006

(54) Clutch apparatus

(75) Inventor: Arthur Schroder, Hambach (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/352,017

(22) Filed: Feb. 9, 2006

(30) Foreign Application Priority Data
Feb. 28, 2005 (DE) 10 2005 008 961.5

(51) Int. Cl. F16H 45/02

(52) U.S. Cl. 192/3.29; 192/109 R

(57) ABSTRACT

A clutch apparatus includes a drive; a housing connected to the drive for rotation in common; a takeoff which can rotate relative to the housing, the takeoff having an axial stop; and a takeoff hub connected to the takeoff for rotation in common, the takeoff hub having an axial stop element and being axially movable relative to the takeoff. A friction clutch mounted in the housing and includes at least one first clutch element connected to the housing for rotation in common, at least one second clutch element connected to the takeoff hub for rotation in common, and means for exerting pressure to shift the clutch from a first position to a second position, wherein the first and second clutch elements are frictionally engaged in one of the positions and disengaged in the other of the positions. The stop element and the stop are separated by a gap A defining a maximum distance in the first position, the gap A being at least partially closed in the second position.

### BACKGROUND OF THE INVENTION

1. Field of the Invention

The invention pertains to a clutch apparatus including a drive, a housing connected to the drive for rotation in common, a takeoff which can rotate relative to the housing, a takeoff hub connected to the takeoff for rotation in common and being axially movable relative to the takeoff, and a friction clutch mounted in the housing. The clutch has at least one first clutch element connected to the housing for rotation in common, at least one second clutch element connected to the takeoff hub for rotation in common, and means for exerting pressure to shift the clutch from a first position to a second position. The first and second clutch elements are frictionally engaged in one of the positions and disengaged in the other of the positions.

2. Description of the Related Art

A clutch device of this type is known from DE 103 15 169 A1. This device has a housing with a drive such as the crankshaft of an internal combustion engine, a takeoff, formed by a gearbox input shaft and free to rotate in the circumferential direction relative to the housing, and a friction clutch, which can be shifted between an engaged position and a released position. The clutch includes a pressure-exerting means such as the piston of a bridging clutch, and a plurality of outer and inner plates, which can be actuated by the pressure-exerting means. The plates act as clutch elements, each of which has at least one friction surface, and (like the pressure-exerting means) can be shifted back and forth in the axial direction to a limited extent.

The inner plates are mounted on an inner plate carrier, which is supported by a torsional vibration damper, where the torsional vibration damper for its own part is provided with a takeoff hub, which is connected nonrotatably but with freedom of axial movement to the takeoff by a set of teeth. The friction clutch assumes its engaged position for the transmission of the torque of the drive via the housing to the takeoff when the pressure-exerting means has arrived in contact with the plate adjacent to it and the plates are thus pressed against each other in the axial direction in a friction-locking manner, where the plate farthest away from the pressure-exerting means in the axial direction is supported against the housing. In contrast, the released position, in which this torque transmission process is at least partially suspended, is present when the pressure-exerting means generates little or no friction-locking connection between the plates.

Especially in the engaged position, the inner plates of the friction clutch can undergo a certain elastic deflection under the action of the axial forces which are introduced. This produces an undesirable clamping effect on the inner plate carrier, which can lead to an axial displacement of the carrier in the direction toward the takeoff wall of the housing opposite the pressure-exerting means. The torsional vibration damper and thus also the takeoff hub mounted on it are necessarily carried along by this movement of the inner plate carrier until it is stopped by an axial bearing located between the takeoff hub and the takeoff wall of the housing. Because this axial bearing is mounted on a comparatively large diameter around the takeoff, relatively high relative rotational velocities occur between the takeoff hub and the takeoff wall of the housing. For this reason, the axial bearing is designed as a roller bearing to minimize the frictional effects more effectively. As a result, it is not possible to avoid damage under all possible conditions, especially when axial shocks are introduced. The cost of buying and installing a roller bearing, furthermore, is not inconsiderable.

Another problem with this design is that a bearing journal on the drive wall of the housing, an additional bearing between this bearing journal and the takeoff hub, and the previously mentioned axial bearing across from the takeoff wall are arranged adjacent to each other in a row, so that, if manufacturing tolerances lead to an unfavorable accumulation of oversizes, the takeoff hub will have an undesirably high degree of axial mobility, whereas, in the case of the unfavorable accumulation of undersizes, the takeoff hub will be clamped in position axially with almost no freedom of movement. In the case of an overaccumulation of oversizes, the axial mobility of the pressure-exerting element in the direction toward the takeoff wall of the housing can be completely used up even before the axial escaping movement of the takeoff hub has come to an end at the axial bearing. This means that the friction clutch cannot engage completely, and this leads in turn to a limit on the amount of torque which can be transmitted. In the case of an overaccumulation of undersizes, conversely, the pressure-exerting element can execute only part of its engaging movement, because the plates have entered into friction-locking connection with each other even before the fully engaged position has been reached, whereas the takeoff hub no longer has any ability to move axially in the direction toward the takeoff wall of the housing.

Finally, there is the problem that, because of the toothed engagement between the takeoff hub and the takeoff, there is a certain amount of radial play in the connection between the two components. Therefore, not even the axial bearing assigned to the takeoff hub is enough to avoid completely the occurrence of limited tipping movements of the takeoff hub with respect to the axis of rotation of the clutch device. These tilting movements can at the very least impair the functional behavior of the friction clutch and of the torsional vibration damper and can even lead to damage to these components.

Another clutch device is known from DE 103 30 031 A1. This device has a hydrodynamic circuit, which consists of a pump wheel, a turbine wheel, and a stator, and therefore acts as a hydrodynamic torque converter. The converter also has a friction clutch with a piston and a torsional vibration damper, which acts between the piston and the turbine wheel. The turbine wheel is connected nonrotatably but with freedom of axial movement by a takeoff hub to a takeoff in the form of a gearbox input shaft, and is supported axially in the direction toward the takeoff side by a bearing on the freewheel of the stator. In addition, the stator is provided with a support hub, which has an axial extension pointing away from the friction clutch, by means of which the support hub is supported by its radially inner side against a radial support element in the form of a support shaft.

Because the takeoff hub is not held in position axially toward the drive side by a bearing, tilting movements of the turbine wheel cannot be excluded, especially before the clutch device is installed and thus the turbine wheel hub has not yet been seated on the takeoff, that is, on the gearbox input shaft. As a result, it is not impossible for the torsional vibration damper to shift into an off-center position. This interferes with the installation of the clutch device and can even make such installation impossible. The stator is also exposed to the risk of tilting before the clutch device has been installed and thus before the turbine wheel is able to give the stator the necessary axial support.

### SUMMARY OF THE INVENTION

The invention is based on the task of designing a clutch apparatus with a housing and a takeoff hub in such a way that, without causing any functional disadvantages, it is possible to eliminate the axial bearing between the takeoff hub and the takeoff wall of the housing, to avoid effectively any tolerance-related problems with the range of axial movement of the takeoff hub, and effectively to prevent the takeoff hub and/or support hub from tilting.

This task is accomplished by providing the takeoff hub with a stop element which acts essentially in the axial direction, and by providing the takeoff with a stop which cooperates with the stop element. This achieves the goal of holding the takeoff hub in a precisely defined position with respect to the takeoff and thus ultimately with respect to a takeoff wall of the housing, because in the normal case the takeoff of a clutch device of this type is already positioned axially with respect to its housing and thus with respect to the drive. The use of an axial bearing directly between the takeoff hub and the takeoff-side housing wall or between the stator and the takeoff-side housing wall thus becomes completely unnecessary. Because the takeoff in a clutch device usually consists of a gearbox input shaft, on which the takeoff hub is mounted nonrotatably but with freedom of axial movement, the contact between the stop element and the stop is free of relative movement, both in the radial direction and in the circumferential direction, and is thus not subject to wear.

By ensuring that the gap between the stop element and the stop in a first position—either the engaged position or the released position—has a maximum distance A, the takeoff hub will “float” in the axial direction with respect to the takeoff, and thus the degree to which the takeoff hub can shift axially relative to the housing of the clutch device is precisely defined. In the direction toward the drive-side housing wall, the takeoff hub can enter into working axial connection only with a pressure-exerting means, such as the piston of a bridging clutch or with the hub on which the pressure-exerting means is mounted. There are therefore very few points—in the most favorable case, only a single point—located axially between the drive-side housing wall and the takeoff-side housing wall which are subject to manufacturing tolerances, which means that it is impossible for oversizes or undersizes to accumulate to the point that they can cause trouble. The maximum distance A for the gap can be specified with a degree of precision sufficient to ensure that the pressure-exerting means will arrive in its first position toward the takeoff side housing wall without interference. When the clutch device is designed in such a way that this first position represents the engaged position of the pressure-exerting means, it is also possible, on the basis of the ability to specify the size A of the gap precisely, to ensure that the clutch elements, which can be in the form of plates, will be actuated sufficiently to transmit all of the available torque.

The situation on the support hub assigned to the stator is comparable. By designing the takeoff hub with a stop element component acting essentially in the axial direction and by designing a stationary radial support element such as a support shaft with a stop component assigned to the stop element component, the support hub is given a precisely defined position in relation to the radial support element and thus to the takeoff-side housing wall. There is therefore no need for an axial bearing between the support hub or the stator assigned to the support hub and the takeoff-side housing wall.

By specifying a maximum distance B for the gap between the stop element component and the stop component in a first position—either the engaged position or the released position—of the pressure-exerting means of the friction clutch, the support hub will “float” with respect to the radial support element, and thus not only the degree to which the stator assigned to the support hub can move axially relative to the housing of the clutch device is precisely defined but also the relative freedom of axial movement of the turbine wheel assigned to the takeoff hub is precisely defined, provided that the turbine wheel is supported axially by the stator against the housing of the clutch device, here especially against the takeoff-side housing wall.

Advantageous embodiments of the stop element and of the stop, each representing a radial projection of the part on which it is mounted—i.e., the takeoff hub or the takeoff—are contemplated. An especially compact design is obtained by inserting the stop element positively in a recess in the takeoff hub and/or by designing the stop element as a circlip. The amount of work involved in producing the stop is minimal if it is formed right on the takeoff, this design being especially advantageous in cases where the takeoff is a gearbox input shaft.

Other embodiments are directed at advantageous elaborations of the stop element component and of the stop component, where in each case a radial projection is provided on the associated mounting component, i.e., on the support hub or the radial support element. The manufacturing effort can be minimized here by inserting the stop component in a positively locking manner in a radial recess in the radial support element and/or by designing it as a support ring, this design being advantageous especially in cases where the radial support element is a support shaft. In the case of the stop element component, furthermore, the manufacturing work can be minimized by forming it directly on the support hub.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows the upper half of a longitudinal section through a clutch device;

FIG. 2 shows an enlarged detail of the circled area marked “X” in FIG. 1;

FIG. 3 is similar to FIG. 2, but shows a different design;

FIG. 4 is similar to FIG. 2, but shows a different design;

FIG. 5 is similar to FIG. 2, but shows a different design;

FIG. 6 shows the upper half of a longitudinal section through another clutch device;

FIG. 7 shows an enlarged detail of the circled area marked “Y” in FIG. 6;

FIG. 8 is similar to FIG. 7 but shows a different design;

FIG. 9 is similar to FIG. 7 but shows a different design; and

FIG. 10 is similar to FIG. 7 but shows a different design.

### DETAILED DESCRIPTION OF THE PRESENTLY PREFERRED EMBODIMENTS

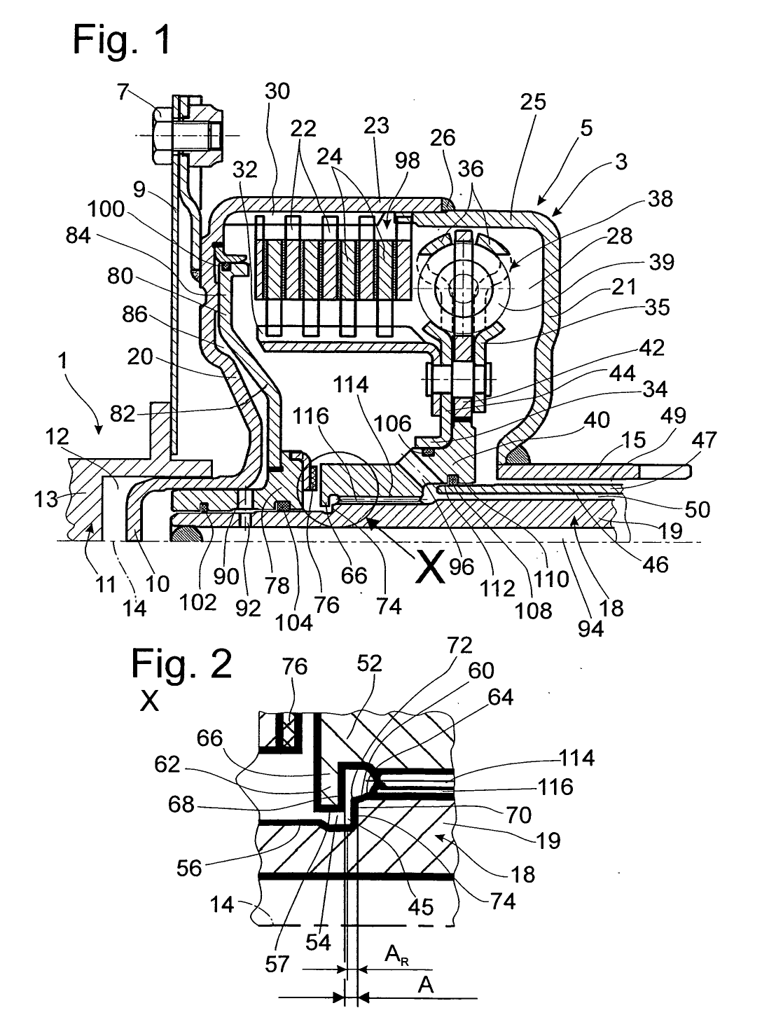

FIG. 1 shows a schematic diagram of a drive train 1 with an inventive clutch device 3. The clutch device 3 includes a housing 5, which can be connected for rotation in common by means of a plurality of fastening elements 7 and a connecting element 9 such as a flexplate to a drive 11, such as the crankshaft 13 of an internal combustion engine. In the area of the axis of rotation 14, the clutch device has a bearing journal 10, which is mounted in a centering guide 12, formed on the drive 11. On the axial side away from the drive 11, the housing 5 has a housing hub 15, which is connected, for example, to a transmission arrangement (not shown), where it causes a fluid delivery pump (also not shown) to rotate. Mounted concentrically to the housing hub 15 is a takeoff 18, the free end of which projects into the housing 5. This takeoff 18 can be, for example, a gearbox input shaft 19.

The housing 5 has a drive-side housing wall 20, which extends from the bearing journal 10 essentially in the radially outward direction, and a takeoff-side housing wall 21, which extends from the housing hub 15 essentially in a radially outward direction. These two housing walls 20, 21 merge in their radially outer areas with the outer housing shells 23, 25, which connect the two housing walls 20, 21 axially together, these shells being connected pressure-tight to each other by means of, for example, a weld 26 to prevent the loss of the fluid transport medium from the fluid chamber 28 enclosed by the housing walls 20, 21 and the outer shells 23, 25.

In the fluid chamber 28 of the housing 5, there is a plurality of first clutch elements 22, which are connected for rotation in common to the housing, here in particular to the outer housing shell 23, which acts as the drive-side clutch element carrier 30, and a plurality of second clutch elements 24, which are mounted nonrotatably on a takeoff-side clutch element carrier 32, to form a friction clutch 98. The takeoff-side clutch element carrier 32 is supported radially by a first cover plate 34 of a torsional vibration damper 38 on the takeoff hub 40 of the torsional vibration damper 38. The first cover plate 34 cooperates with a second cover plate 35 to form the input part 36 of the torsional vibration damper 38. The input part 36 is able to rotate against the action of an energy-storing device 39 relative to an output part 42 in the form of a hub disk 44, the hub disk 44 being mounted nonrotatably on the takeoff hub 40. A support shaft 47, which is permanently connected to the housing and which serves as a radial support element 46, cooperates with the housing hub 15 to form the boundaries of a first annular channel 49, whereas it cooperates with the takeoff 18 to form the boundaries of a second annular channel 50. In addition, the takeoff hub 40 is provided over at least a portion of its axial dimension with a set of teeth 114, which cooperates with an opposing set of teeth 116 on the takeoff 18 to form a connection 118 for rotation in common while still allowing freedom of relative axial movement.

As a result of the connection 118 for rotation in common, a centering effect is achieved via the tip and root diameters of the set of teeth 114 and the opposing set of teeth 116.

The takeoff hub 40 is supported in a “floating” manner in the axial direction within a range characterized by the gap 45 with a maximum distance A, shown enlarged in FIG. 2. The hub therefore has a limited freedom of relative axial mobility with respect to the takeoff 18 and ultimately also with respect to the housing 5, insofar as the takeoff is held in position axially with respect to the drive 11 and thus with respect to the housing 5.

The takeoff hub 40 is provided with a radial projection 62 pointing toward the takeoff 18. The radially free end 57 of this projection, i.e., the end facing the takeoff 18, extends toward the base surface 56 of the shaft of the takeoff 18, leaving a radial gap 54. On the axial side of the radial projection 62 facing the takeoff-side housing wall 21, the takeoff 18 is provided with a diameter increase 60, essentially in the form of a step, which acts as a second radial projection 64. The two radial projections 62, 64 work together when a first contact surface 68 of the first radial projection 62, which serves as the stop element 66—this first contact surface being provided on the axial side of the projection facing the takeoff-side housing wall 21 and thus facing the second radial projection 64—has entered into contact with a second contact surface 70, which is provided on the free radial end 72 of the second radial projection 64, which serves as the stop 74, this second contact surface facing the first radial projection 62.

The side of the takeoff hub 40 facing the drive-side housing wall 20 can arrive in axial contact with an axial bearing 76, preferably designed as a plain bearing. The axial bearing 76 for its own part is fastened to the hub 78 of a pressure-exerting means 80. The pressure-exerting means 80 is designed as the piston 82 of a bridging clutch 84, serving as a friction clutch 98, and can be brought into working connection with the adjacent clutch element 22.

The pressure-exerting means 80 is located axially between the drive-side housing wall 20 and the fluid chamber 28 and cooperates with the drive-side housing wall 20 to form the boundaries of a pressure chamber 86, which is connected to a center bore 94 in the gearbox input shaft 19 by means of flow passages 92 in the drive 18, i.e., in the gearbox input shaft 19. In addition, flow channels 96 are provided in the takeoff hub 40, through which a flow connection can be established between the channel 50 and the fluid chamber 28. The latter is sealed off against the pressure chamber 86 by a seal 100; the gearbox input shaft 19 is sealed off in a similar manner from the hub 78 of the pressure-exerting means by seals 102 and 104; the takeoff hub 40 is sealed off against the first cover plate 34 of the torsional vibration damper 38 by a seal 106; and the takeoff hub 40 is sealed off against the support shaft 47 by a seal 108. The reason for the seals 106 and 108 is to prevent a significant percentage of the flow conducted from channel 50 via the flow passages 96 to the fluid chamber 28 from passing either via the torsional vibration damper 36 into the channel 49 or directly into this channel 49 without having first reached and cooled the clutch elements 22 and 24. In contrast, the seals 102 and 104 between the gearbox input shaft 19 and the hub 78 of the pressure-exerting means prevent the fluid being supplied to build up the pressure in the pressure space 86—this fluid being conducted to the pressure space via the center bore 94 of the gearbox input shaft 19 and via the flow passages 90, 92—from leaking away into the fluid chamber 28.

In FIG. 1, the pressure-exerting means 80 is in its released position, in which no pressure is being applied to the clutch elements 22, 24, and the clutch elements are therefore unable to transmit to the takeoff 18 any of the torque originating from the drive 11 and conducted to the housing 5. As a result of the buildup of pressure in the pressure space 86 until it is greater than that in the fluid chamber 28, the pressure-exerting means 80 is shifted axially toward the clutch elements 22, 24 and, by acting on the first connecting element 22 closest to the pressure-exerting means 80, the pressure-exerting means presses the other connecting elements 22, 24 closer and closer together, because they are prevented from escaping toward the takeoff-side housing wall 21 by the last clutch element 22 closest to that wall, this last element being attached permanently to the outer housing shell 25. This movement is over as soon as the pressure-exerting means 80 has reached a defined end position, which represents the engaged position.

During this engaging movement, the pressure-exerting means 80 carries along the hub 78 attached to it in the direction toward the takeoff hub 40. Because the diameter of the flow passage 90 in the hub 78 of the pressure-exerting means is larger than that of the flow passage 92 in the gearbox input shaft 19, it is possible for fluid to continue to enter the pressure space 86. As soon as the hub 78 of the pressure-exerting means has entered into working connection via the axial bearing 76 with the takeoff hub 40, furthermore, the takeoff hub 40 also starts to participate in the movement of the hub 78.

FIG. 2 shows the takeoff hub 40 in an axial position in which no axial movement of the takeoff hub 40 relative to the gearbox input shaft 19 has yet begun. The width of the gap 45 axially between the stop element 66 and the stop 74 is thus at its maximum, which ensures that there is the distance A between the stop element 66 and the stop 74. This distance A is preferably designed so that it is only partially used up during the movement of the hub 78 of the pressure-exerting means toward the engaged position of the pressure-exerting means 80. There thus remains a residual distance AR, by means of which, first, unfavorable oversizes in the area of the hubs 40 and 78 can be absorbed, and, second, a compensation space is created, which, for example, is necessary when deformations of the clutch elements 22, 24 and, as a result, the tilting of those elements with respect to the takeoff-side clutch element carrier 32 leads to even more axial displacement of the takeoff hub 40 toward the takeoff-side housing wall 21. This axial displacement of the takeoff hub 40 reaches its ultimate end, however, as soon as the residual distance AR is also used up and the stop element 66 has come to rest against the stop 74.

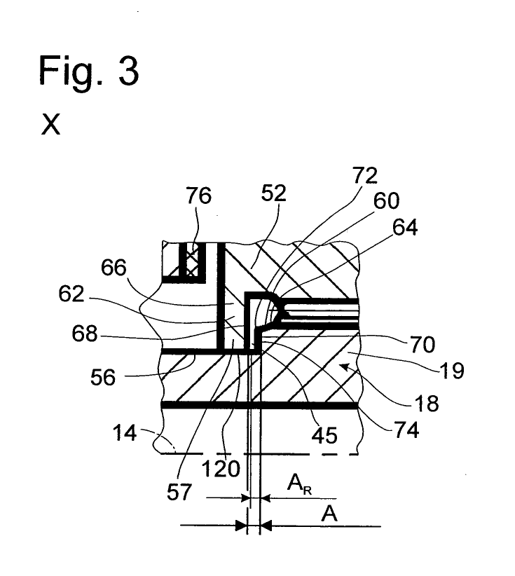

An alternative to this design is shown in FIG. 3, in which the free radial end 57 of the radial projection 62 of the takeoff hub 40 extends all the way to the base 56 of the shaft of the takeoff 18. As a result, the takeoff hub 40 is provided with a centering support surface 120 on its free radial end 57. Because this centering surface centers the hub on the takeoff 18, the connection 118 for rotation in common is no longer required to perform this function.

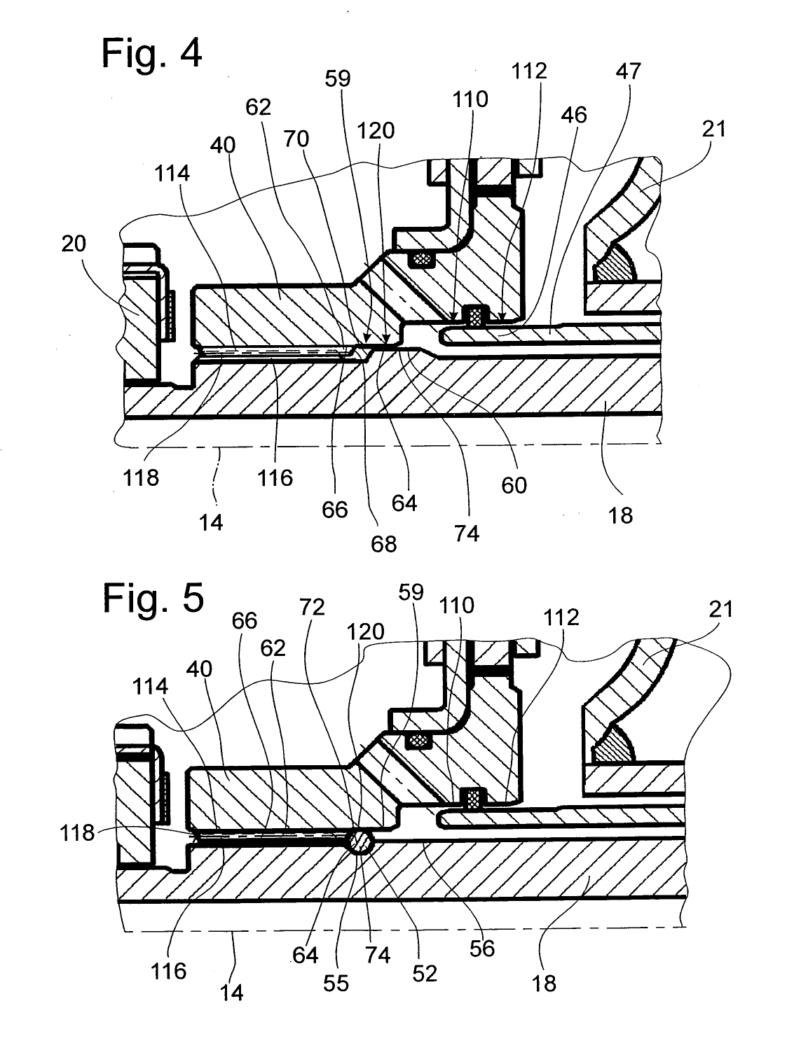

FIG. 4 shows a design of the takeoff hub 40 in which the centering support surface 120 is provided on the base surface 59 of the hub in the axial part of the takeoff 18 which has the increased diameter 60 and which therefore serves as the radial projection 64. The takeoff hub 40 is thus centered by the interaction between the centering support surface 120 and the radial projection 64. In this design, the set of teeth 114 on the takeoff hub 40 projects radially beyond the base 59 of the hub toward the takeoff 18 and thus forms a radial projection 62, which acts as the stop element 66. The axial side of this stop element which faces the radial projection 64 forms the first contact surface 68, whereas the second contact surface 70 facing the set of teeth 114 is provided on the associated axial side of the radial projection 64, which therefore acts as the stop 74.

At the end pointing toward the takeoff side housing wall 21, the takeoff hub 40 has a radial support surface 112 on the radially inner side 110. By means of this radial support surface, the hub can also be supported by the radially adjacent radial support element 46, that is, by the support shaft 47. The goal here is at least to reduce the tilting movements of the takeoff hub 40 with respect to the axis of rotation 14. Of course, the takeoff hub 40 can also be supported by the radial support element 46 in the designs according to FIGS. 1-3 and is therefore not only shown in FIG. 1 but also designated there by the appropriate reference numbers.

FIG. 5 shows a design in which the takeoff hub 40 is again centered on the takeoff 18 by means of the connection 118 for rotation in common by way of the tip and root circles of the set of teeth 114 and the opposing set of teeth 116. In addition, as also in the case of FIG. 4, the set of teeth 114 serves as the radial projection 62, which is assigned to the takeoff hub 40 and which projects beyond the hub base 59 to form the stop element 66, whereas the radial projection 64, which is assigned to the takeoff 18 and serves as the stop 74, is formed by a circlip 52, which fits into a radial recess 55 in the takeoff 18, at least the radially free end 72 of the circlip projecting beyond the base 56 of the takeoff 18 toward the base 59 of the takeoff hub 40. When the radially free end 72 of the circlip 52 comes to rest against the hub base 59 of the takeoff hub 40, the surface of the hub which is in contact with the circlip 52 acts as the centering support surface 120.

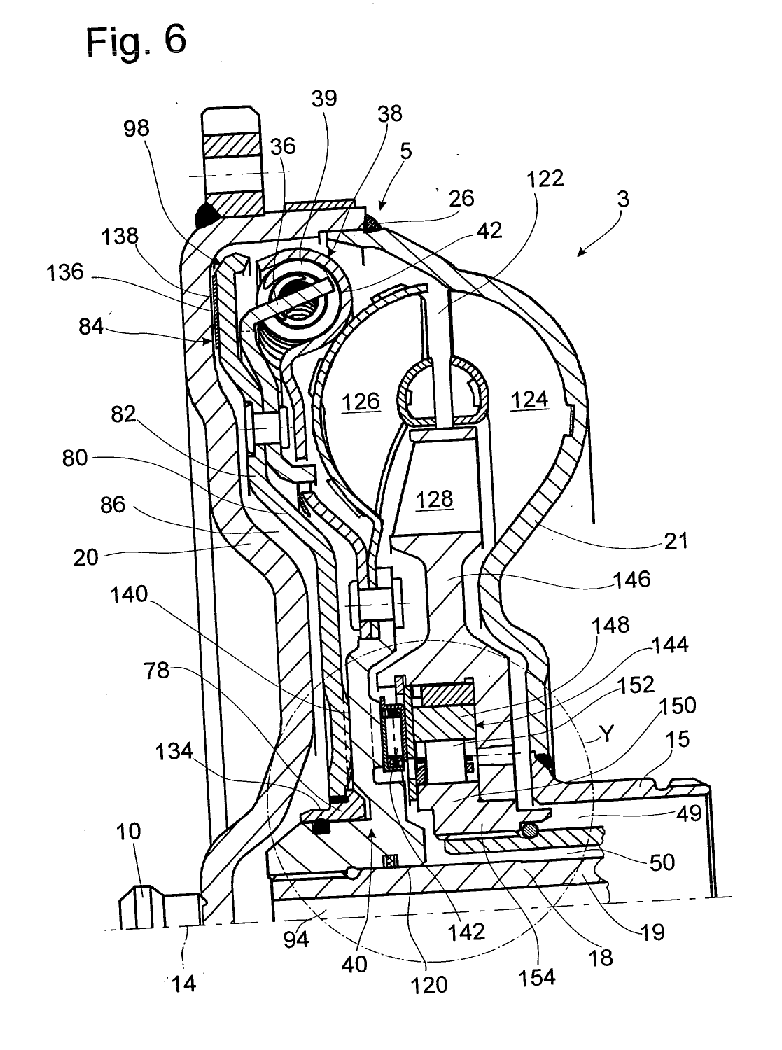

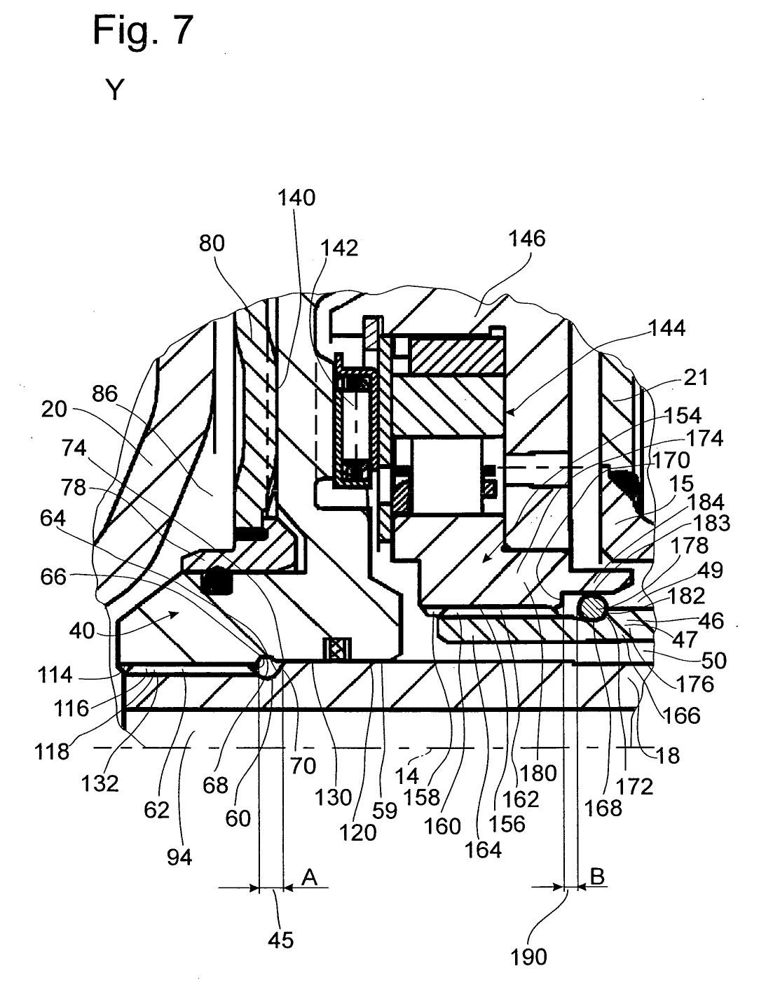

FIG. 6 shows a clutch device with a different operating principle, in which analogous components are designated by the same reference numbers as those used for the clutch device discussed on the basis of FIG. 1. The connection to a drive (not shown in FIG. 6 either) can be accomplished in the same way, as already explained on the basis of FIG. 1. For the additional reference numbers and a more detailed illustration of the object of the application, reference is made to FIG. 7, which shows an isolated and enlarged view of the circled area relevant to the invention marked “Y” in FIG. 6.

As FIG. 6 shows, the clutch device 3 comprises a housing 5, which has a bearing journal 10 in the area of an axis of rotation 14. On the axial side away from the bearing journal 10, the housing 5 has a hub 15. Arranged concentrically to this hub is a takeoff 18, the free end of which projects into the housing 5. This takeoff 18 can be formed by, for example, a gearbox input shaft 19.

The housing 5 has a drive-side housing wall 20, extending from the bearing journal 10 essentially in a radially outward direction, and a takeoff side housing wall 21, extending from the housing hub 15 in an essentially radially outward direction. These two housing walls 20, 21 are connected in a pressure-tight manner to each other in their radially outer areas by means of, for example, a weld 26, to prevent the loss of fluid transport medium from the hydrodynamic circuit 122, enclosed by the housing walls 20, 21. This circuit is formed by a pump wheel 124, connected nonrotatably to the housing, a turbine wheel 126, and a stator 128.

The turbine wheel 126 has a takeoff hub 40, which, as shown in FIG. 7, has a centering support surface 120 on the hub base 59, by which it is centered on a first takeoff section 130 of the takeoff 18, which axially overlaps the centering support surface 120. The first takeoff section 130 is designed with a diameter increase 60, which makes it larger than the second takeoff section 132, which is closer to the drive. This diameter increase can therefore be interpreted as a radial projection 64, which provides a stop 74 on the takeoff 18. So that the stop 74 can fulfill its function, the radial projection 64 created by the diameter increase 60 has a contact surface 70, which can be brought into working connection with a contact surface 68 on the takeoff hub 40. The contact surface 68 of the takeoff hub 40 is provided on the set of teeth 114, which starts from the hub base 59 and extends radially inward toward the second takeoff section 132 and engages there with an opposing set of teeth 116 on the takeoff to form a connection for rotation in common 118, which still allows relative axial movement between the takeoff hub and the takeoff 18. The set of teeth 114 therefore acts as a radial projection 62, pointing in the direction of the takeoff 18, and thus acts as the stop element 66 of the takeoff hub 40.

The radially outer mounting surface of the takeoff hub 40 accepts a hub 78 for a pressure-exerting means 80 in such a way as to allow relative rotation, where the pressure-exerting means 80, as shown in FIG. 6, is part of a friction clutch 98 in the form of a bridging clutch 84. The pressure-exerting means 80 can be realized as a piston 82, and the hub 78 can be realized as the base 134 of the piston. Axially between the pressure-exerting means 80, the radially outer area of which carries a friction lining 136 on the axial side facing the drive-side housing wall 20, and the drive-side housing wall 20, a pressure space 86 is provided, which can be supplied with viscous transport medium through a center bore 94 in the takeoff 18.

The input part 36 of a torsional vibration damper 38 is fastened to the axial side of the pressure-exerting means 80 facing away from the drive-side housing wall 20. The input part is connected to the output part 42 of the torsional vibration damper 38 by energy-storing devices 39. The output part 42 is fastened in turn to the takeoff hub 40 and thus to the turbine wheel 126.

In the engaged position, the friction lining 136 of the pressure-exerting means 80 rests against the drive-side housing wall 20, which thus acts as a clutch element 138. Torque transmitted from the housing 5 to the pressure-exerting means 80 is conducted via the torsional vibration damper 38 to the takeoff hub 40 and from there via the connection for rotation in common 118 to the takeoff 18. In the axial direction, the takeoff hub 40 is free of axial forces acting in the direction toward the takeoff-side housing wall 21, so that, as shown in FIG. 7, a gap 45, creating a distance A, is present between the first contact surface 68 on the takeoff hub 40 and the second contact surface 70 on the takeoff 18.

In the released position, the pressure-exerting means 80 is in a position in which it exerts, via a contact surface 140, an axial force, directed toward the takeoff side housing wall 21, on the turbine wheel 126. This axial force is then conducted via an axial bearing 142 to the freewheel 144, which holds the hub 146 (FIG. 6) of the stator 128. The freewheel 144 consists of a radially outer freewheel ring 148, a radially inner freewheel ring 150, and a clamping body 152, located radially between the two freewheel rings 148, 150. The radially inner freewheel ring 150 serves as a support hub 154 for the stator 128 and is mounted on the support shaft 47, which is permanently connected to the housing and which acts as the radial support element 46. The support shaft 47 has a ring-shaped channel 49 for viscous transport medium radially between itself and the housing hub 15, and a further channel 50 between itself and takeoff 18, which serve to absorb the axial force introduced from the pressure-exerting means 80. For this purpose, the support hub 154 and the support shaft 47 are designed as described below:

Proceeding from a hub base 156 (FIG. 7) of the support hub 154, a set of teeth 158 extends toward a first support shaft section 164 of the support shaft 47, on which an opposing set of teeth 160 is formed, which cooperates with the set of teeth 158 to form a connection for rotation in common 162, which still allows relative axial movement between the support hub 154 and the support shaft 47. On the axial side facing the takeoff-side housing wall 21, the support hub 154 has a first axial contact surface 170 for a support ring 178, which works together with a second axial support surface 172 on the support shaft 47, namely, in the area where the diameter increase 168 occurs, which leads from the first support shaft section 164 to the second support shaft section 166. Thus the axial section of the support hub 154 carrying the set of teeth 158 functions as the first radial projection 180 of a stop element component 174, whereas the diameter increase 168 on the support shaft 47 functions as the second radial projection 182 of the stop component 176.

Axially between the first radial projection 180 of the stop element component 174 and the second radial projection 182 of the stop component 176, a distance B is created for a gap 190, which is present when the pressure-exerting means 80 is not exerting any axial force in the direction toward the takeoff side housing wall 21, such as when, for example, the pressure-exerting means 80 is located in its engaged position. When, however, the pressure-exerting means 80 is exerting such axial force, such as when it is in its released position, then the gap 190, as a result of the continuing approach of the stator 128 to the takeoff-side housing wall 21, is reduced steadily until the stop element component 174 has come to rest via its support ring 178 against the stop component 176 and the gap 190 has been used up completely. Because the support shaft 47 is permanently connected to the housing 5, the stator 128 is held in a defined axial position.

On the axial side facing the support ring 178, the support hub 154 has an axial extension 184. The radially inner surface of this extension serves as a radial support surface 183, which radially supports the support hub 154 by way of the support ring 178 on the support shaft 47 and thus provides additional security against the tilting movements of the support hub 154 and thus of the stator 128 with respect to the axis of rotation 14 of the clutch device 3.

The remaining figures pertain to different designs of the support hub 154. Only the reference numbers which pertain to the differences versus the design according to FIG. 7 are entered, and only these differences are described.

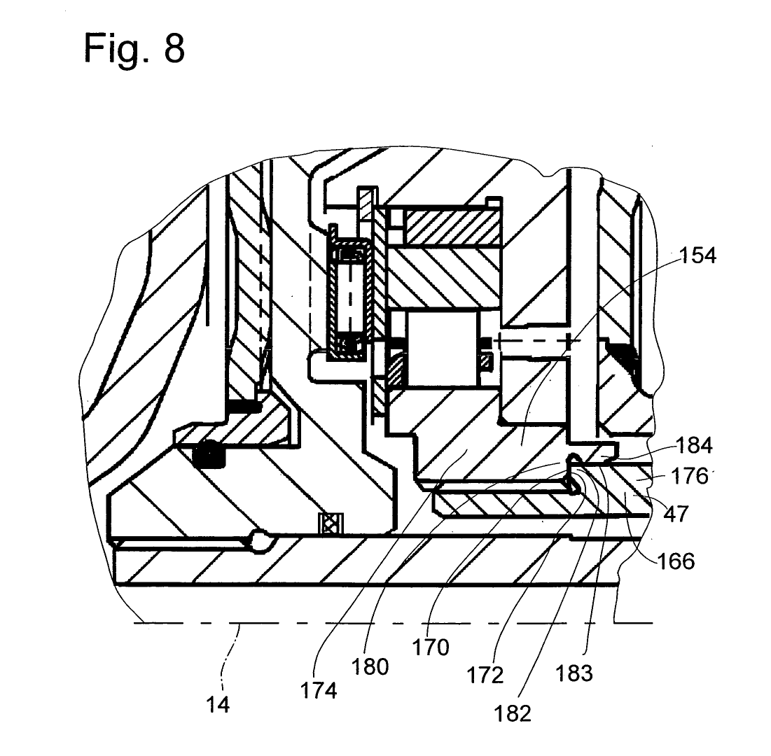

In FIG. 8, the design and function of the support hub 154 are the same as those discussed on the basis of FIG. 7, but the radial support surface 183 of the axial extension 184 rests directly against the radially outer surface of the second support shaft section 166 of the support shaft 47. The direct contact between the axial extension 184 and the support shaft section 166 is not critical, even if both parts are made of steel, because they do not rotate relative to each other.

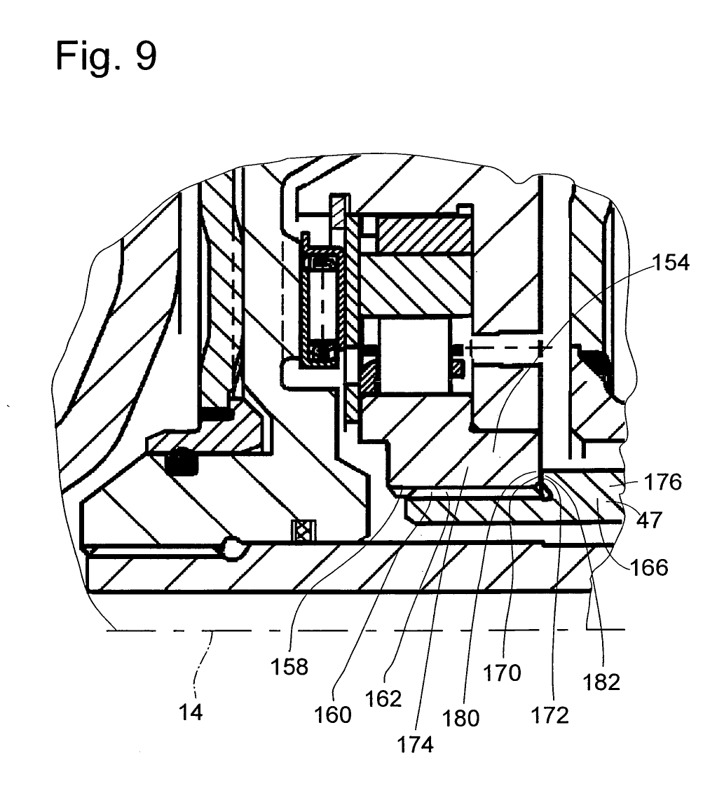

According to FIG. 9, the support hub 154 can also be designed without an axial extension. In contrast to the other designs, the centering of the support hub 154 on the support shaft 47 is accomplished here only by means of the connection for rotation in common 162, in that the set of teeth 158 of the support hub 154 is in dynamically centering connection with the opposing set of teeth 160 of the support shaft 47 by way of their respective tip and root diameters.

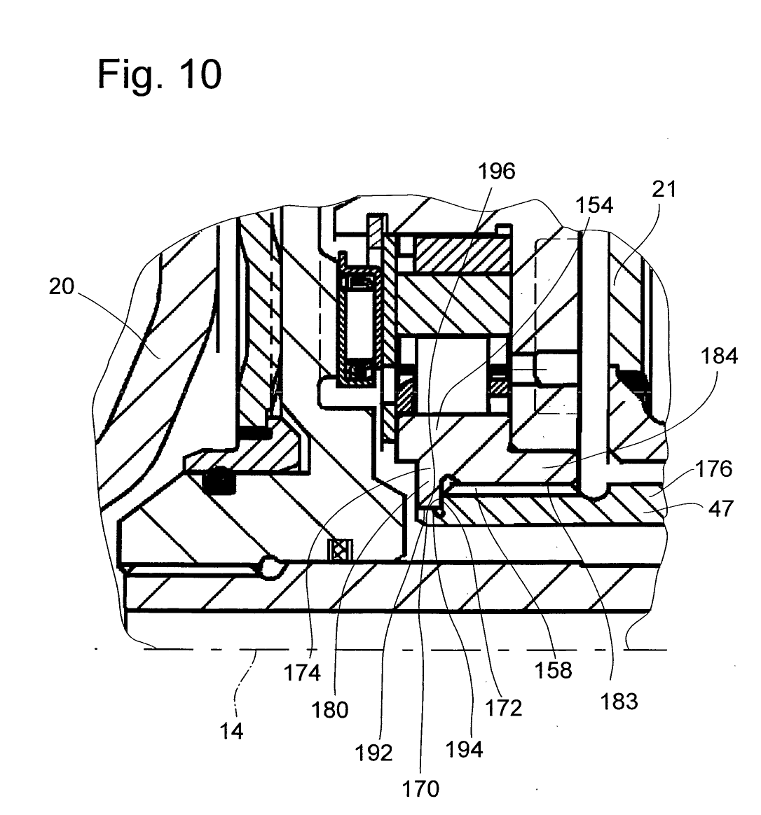

In FIG. 10, part of the radial support surface 183 of the axial extension 184, which is on the axial end of the support hub 154 facing the takeoff-side housing wall 21, carries the set of teeth 158. The function of the stop element component 174 is fulfilled by a radial projection 180, which is provided on the support hub 154, namely, on the axial end facing the drive-side housing wall 20. This radial projection has a first stop surface 170 on the axial side facing the takeoff-side housing wall 21, and this first stop surface can be brought into contact with a second stop surface 172 provided on the support shaft 47. The second contact stop 172 is created as a result of the production of a radial recess 192 in the support shaft 47, where the latter, as a result of the second contact surface 172, functions as the stop component 176. Because the radial projection 180 of the support hub 154 penetrates radially into the radial recess 192 and because its free end 196, i.e., the end facing the base 194 of the recess in the support shaft 47, comes to rest against the recess base 194, the support hub 154 is centered with respect to the support shaft 47, and the support hub 154 is also stabilized against tilting movements around the axis of rotation 14 of the clutch device 3.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A clutch apparatus comprising:
a drive;
a housing connected to the drive for rotation in common;
a takeoff which can rotate relative to the housing, the takeoff having an axial stop;
a takeoff hub connected to the takeoff for rotation in common, the takeoff hub having an axial stop element and being axially movable relative to the takeoff;
a friction clutch mounted in the housing and comprising at least one first clutch element connected to the housing for rotation in common, at least one second clutch element connected to the takeoff hub for rotation in common, and means for exerting pressure to shift the clutch from a first position to a second position, wherein the first and second clutch elements are frictionally engaged in one of said positions and disengaged in the other of said positions;
wherein said stop element and said stop are separated by a gap A defining a maximum distance in said first position, said gap A being at least partially closed in said second position.

2. The clutch apparatus of claim 1 wherein the takeoff hub has a radial projection forming the stop element, the stop element radially overlapping the stop, the stop element and the stop having respective mutually facing first and second contact surfaces.

3. The clutch apparatus of claim 1 wherein the takeoff has a radial projection forming the stop.

4. The clutch apparatus of claim 1 wherein the stop element is formed as one piece with the takeoff hub.

5. The clutch apparatus of claim 2 wherein the takeoff comprises a shaft having a base and a radial projection which extends from the base to a free end and forms the second contact surface, wherein the radial projection of the takeoff radially overlaps the first contact surface.

6. The clutch apparatus of claim 5 wherein the base has a circumferential recess which receives a circlip forming the radial projection of the takeoff.

7. The clutch apparatus of claim 6 wherein the circlip extends to the takeoff hub.

8. The clutch apparatus of claim 1 wherein the takeoff hub comprises a base and a first set of teeth which extend radially from the base toward the takeoff, the first set of teeth forming the stop element.

9. The clutch apparatus of claim 9 wherein the takeoff comprises a shaft have a base and a second set of teeth which extend radially and engage the first set of teeth to connect the takeoff to the takeoff hub for rotation in common with freedom of axial movement.

10. The clutch apparatus of claim 5 wherein the takeoff hub comprises a base, a radial projection which extends from the base to a free end, and a centering support surface on one of the base and the free end, wherein the centering support surface is in contact with the takeoff.

11. The clutch apparatus of claim 1 wherein the takeoff hub comprises a base and a radial support surface axially adjacent to the base, the radial support surface facing radially inward.

12. The clutch apparatus of claim 11 further comprising a radial support element formed by a support shaft fixed to said housing, said support element supporting said radial support element of said hub.

13. The clutch apparatus of claim 1 further comprising:
a pump wheel;
a turbine wheel;
a stator with a support hub having an axial extension pointing away from the friction clutch and serving as a stop element component;
a radial support element formed by a support shaft fixed to the housing, the radial support element having a stop component which is overlapped by the axial extension,
wherein said stop element component and said stop component are separated by a gap B defining a maximum distance in said first position, said gap B being at least partially closed in said second position.

14. The clutch element of claim 13 wherein the support hub has a radial projection forming the stop element component, the stop element component radially overlapping the stop component, the stop element component and the stop component having respective mutually facing first and second contact surfaces.

15. The clutch element of claim 14 wherein the radial support hub has a radial projection forming the stop component.

16. The clutch apparatus of claim 13 wherein the stop element component is formed as one piece with the support hub.

17. The clutch apparatus of claim 13 wherein the support hub comprises a first set of teeth which extend radially toward the radial support element, the first set of teeth forming the stop element component, the radial support element comprising a second set of teeth which extend radially and engage the first set of teeth to connect the support to the support hub for rotation in common with freedom of axial movement.

18. The clutch apparatus of claim 13 wherein the axial extension has a radial support surface which is supported on the radial support surface.

19. The clutch apparatus of claim 13 wherein the radial support element has a radial projection which contacts the radial support surface of the axial extension.

20. The clutch apparatus of claim 19 wherein the radial support element comprises a support ring which forms the radial projection.

21. The clutch apparatus of claim 20 wherein the radial support element comprises a first support shaft section having a first diameter and a second support shaft section having a second diameter which is larger than the first diameter, the support ring having an outside diameter which is larger than the second diameter.
